(19) United States
(12) Patent Application Publication
(10) Pub. No.: US 2022/0139205 A1
(43) Pub. Date: May 5, 2022

(54) Emergency Alert System with Two Hubs

(71) Applicant: Alertpoint Security, LLC, Kennesaw, GA (US)

(72) Inventor: David Gordon Allen, Acworth, GA (US)

(21) Appl. No.: 17/086,726

(22) Filed: Nov. 2, 2020

(51) Int. Cl. G08B 25/08; H04M 11/04; G08B 25/14; G08B 13/196

(52) U.S. Cl. CPC G08B 25/08; G08B 13/19634; G08B 25/14; H04M 11/04

(57) ABSTRACT

The present disclosure relates to a system and method for an alert management system. Embodiments may include an outlet hub, an LED hub, and a wearable alert activation device. The LED hub may be communicatively coupled to the outlet hub. The system may include wearable alert activation devices communicatively coupled to at least one outlet hub. The one or more wearable alert activation devices may include a transceiver and an activation button communicatively coupled to the transceiver. The wearable alert activation device may be configured to transmit an alert signal that identifies the user and is transmitted in response to a user engaging an alert activation button. Each alert activation button may define a type of alert.

### BACKGROUND

In educational environments, providing a safe and secure learning environment is one of the most daunting challenges facing K-12 schools, universities and colleges today. Additionally, personal safety has become one of the most debilitating workplace stress factors for housekeeping staff today in the hospitality industry. Housekeeping staff and other employees who work alone or in vulnerable areas must deal with the potential for personal harm on a daily basis. Further, with incidents of violence on the rise in retail stores and shopping centers, employee safety has never been more critical. In a public-facing environment, anything can happen at any given moment. In business industries, research shows that employees who feel happy and secure in their workplace are more productive employees. Whether it's a corporate office, manufacturing plant, warehouse or a public-facing branch location, employee peace of mind has a direct impact on the bottom line.

In an effort to reduce incidents of violence in educational environments, hospitality industries, retail stores, and in workplaces generally, everyone is encouraged to report suspicious activity and to seek help quickly to resolve potential threats. However, conventional alert management systems are unable to quickly and efficiently report an emergency or provide an alert to others who can help.

### SUMMARY OF DISCLOSURE

As will be discussed in greater detail below, embodiments of the present disclosure include an alert management system.

In one or more embodiments of the present disclosure, an alert management system is provided. The alert management system may include an outlet hub, an LED hub, and one or more wearable alert activation devices. The outlet hub may be communicatively coupled to a data center. The outlet hub may be configured to receive power from an electrical outlet. The outlet hub may include an outlet hub body and an indicator light positioned on the outlet hub body. The outlet hub may be configured to be releasably attached to the electrical outlet. The LED hub may be communicatively coupled to the outlet hub. The LED hub may include a housing body, a back, a faceplate on the housing body located opposite the back, and at least one LED. The back may be configured to releasably attach the LED hub to a surface and may be configured to releasably attach the housing body to the back. The faceplate may be at least one of a transparent and a semi-transparent material, where the at least one LED may be located within the space created by the faceplate, the housing body, and the back. One or more wearable alert activation devices may be communicatively coupled to at least one outlet hub. The one or more wearable alert activation devices may include a transceiver and an activation button. The transceiver may be configured to communicatively couple the wearable alert activation device to the outlet hub and to the LED hub. The wearable alert activation device may be configured to be affixed to an identification badge and is associated with a particular use. An activation button may be communicatively coupled to the transceiver. The wearable alert activation device may be configured to transmit an alert signal that identifies the user and is transmitted at least partially within a building via the transceiver in response to a user engaging the alert activation button, where the alert activation button may defines a type of alert.

One or more of the following features may be included. The wearable alert activation device may include two or more activation buttons, where each alert activation button may define a different type of alert. The wearable alert activation device of the alert management system may be configured to simultaneously engage two alert activation buttons to transmit a different type of alert then the type of alert transmitted from engaging either of the two alert activation buttons individually. The type of alert may define a different group of recipients for the alert signal and may define a specific illumination color of the LED hub, wherein the LED hub may be configured to illuminate the specific illumination color. The type of alert may define the number of LED hubs that illuminate the specific illumination color and may define the location of the LED hubs that illuminate the specific illumination color. The type of alert may include a building alert, and the building alert may include illuminating all LED hubs communicably coupled to the data center. One or more LED hubs and one or more outlet hubs devices may be positioned throughout a school district. The building may be a school building. The data center may be positioned in the school district. The LED hub may be configured to receive the alert signal and communicate the alert signal to the data center. The outlet hub may be configured to receive the alert signal and communicate the alert signal to the data center. The at least one of the outlet hub and the LED hub may include a backup power supply. The outlet hub may be communicatively coupled to at least one LED hub by a Bluetooth® signal. The outlet hub may be communicatively coupled to the data center by at least one of an Ethernet and a Wi-Fi connection. The outlet hub may be configured to simultaneously communicate the alert signal from the wearable alert activation device to the LED hub and to the data center. The data center may be configured to transmit the alert signal from the wearable alert activation device to one or more client devices. Each client device may be configured to receive from the data center a notification of the alert signal. The notification of the alert signal may include the type of alert signal that was transmitted, a location of the alert signal, and an identity of the user. The data center may be configured to notify one or more LED hubs in a school district through the outlet hub to illuminate a specific illumination color based on at least the type of alert and the location of each LED hub. The LED hub may be configured to receive the alert signal from the wearable alert activation device and relay the alert signal to the outlet hub. If the outlet hub receives the alert signal from the LED hub and the LED hub received the alert signal from the wearable alert activation device, then the outlet hub may simultaneously transmits the alert signal to the data center and may transmit the alert signal to other LED hubs in range. The outlet hub may include a cable cover configured to allow a cable to be mated with a cable connector positioned on the outlet hub body. The cable cover may be configured to surround a portion of the cable with the outlet hub body when the cable cover is releasably attached to the outlet body.

In one or more embodiments of the present disclosure, a method of alert management is included. The method may include engaging at least one of two or more alert activation buttons of a wearable alert activation device. The two or more alert activation buttons may be communicatively coupled to a transceiver. The method may also include activing the transceiver on the wearable alert activation device configured to transmit an alert signal. The wearable alert activation device may be configured to be affixed to an identification badge and may be associated with a particular user. The transceiver may be configured to communicatively couple the wearable alert activation device to an outlet hub and an LED hub. The outlet hub may be communicatively coupled to a data center. The outlet hub may be configured to receive power from an electrical outlet. The outlet hub may be configured to be releasably attached to the electrical outlet. The LED hub may be communicatively coupled to the outlet hub. The LED hub may include a housing body, a back, a faceplate on the housing body located opposite the back, and at least one LED. The back may be configured to releasably attach the LED hub to a surface and may be configured to releasably attach the housing body to the back. The faceplate may be at least one of a transparent and a semi-transparent material. The at least one LED may be located within the space created by the faceplate, the housing body, and the back. The method may further include receiving the alert signal at the outlet hub, the LED hub, or both the outlet hub and the LED hub. The alert signal may include a type of alert defined by the at least the alert activation buttons previously engaged. The method may also include illuminating one or more LED hubs connected with the outlet hub that received the alert signal and notifying with the outlet hub the data center of the alert signal. The method may further include notifying one or more client devices of the alert signal and the alert type from the data center.

One or more of the following features may be included. Simultaneously engaging two alert activation buttons may transmit a different type of alert then the type of alert transmitted from engaging either of the two alert activation buttons individually. The illuminating one or more LED hubs connected with the outlet hub that received the alert signal and the notifying the data center of the alert signal with the outlet hub, may occur simultaneously. The method may further include providing to the one or more client devices the type of alert signal that was transmitted, a location of the alert signal, and an identity of the user.

The details of one or more embodiments and implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an alert management process according to an embodiment of the present disclosure;

FIG. 2 is a diagrammatic view of an alert system according to various embodiments of the present disclosure;

FIG. 3 is a diagrammatic view of an alert system according to various embodiments of the present disclosure;

FIG. 4 is a diagrammatic view of an alert system according to various embodiments of the present disclosure;

FIG. 5 is a diagrammatic view of an alert system according to various embodiments of the present disclosure;

FIG. 6 is a flowchart of another embodiment of an alert management process according to an embodiment of the present disclosure;

FIG. 7A-7C depict different views of an outlet hub according to an embodiment of the present disclosure; and

FIG. 8A-8D depict different views of an LED hub according to an embodiment of the present disclosure.

Like reference symbols in the various drawings indicate like elements.

### DETAILED DESCRIPTION OF THE PREFERRED EMBODIMENTS

### System Overview

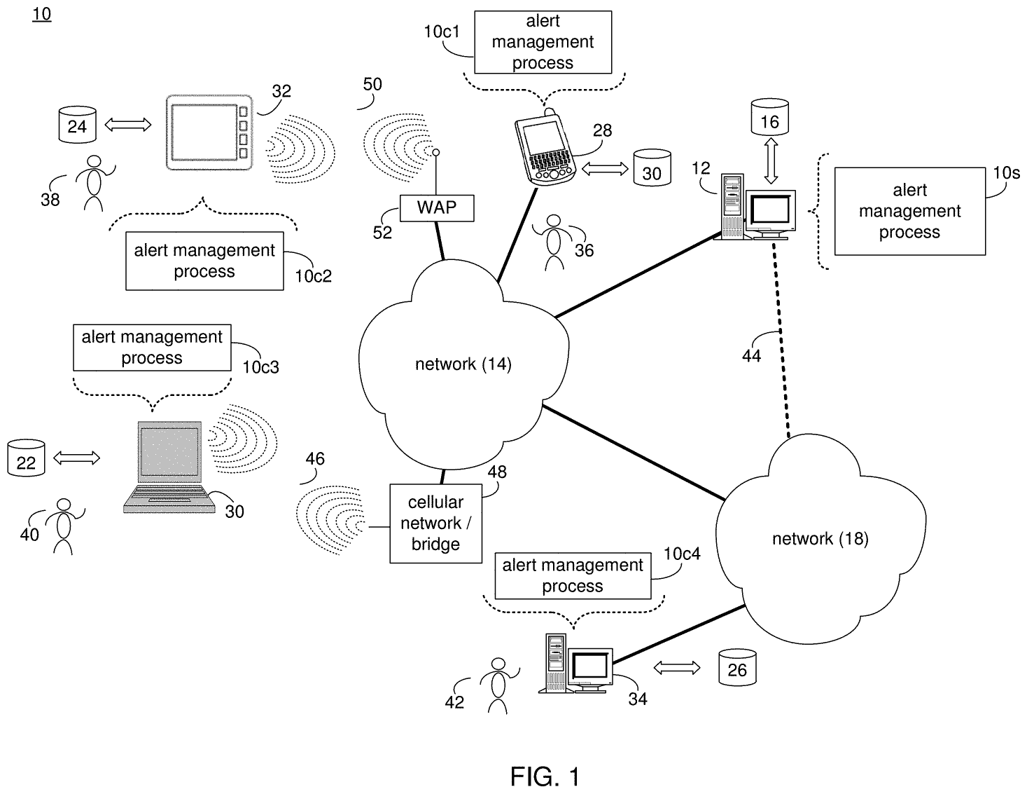

In FIG. 1, there is shown alert management process 10. Alert management process 10 may be implemented as a server-side process, a client-side process, or a hybrid server-side/client-side process.

For example, alert management process 10 may be implemented as a purely server-side process via alert management process 10s. Alternatively, alert management process 10 may be implemented as a purely client-side process via one or more of alert management process 10c1, alert management process 10c2, alert management process 10c3, and alert management process 10c4. Alternatively still, alert management process 10 may be implemented as a hybrid server-side/client-side process via alert management process 10s in combination with one or more of alert management process 10c1, alert management process 10c2, alert management process 10c3, and alert management process 10c4. Accordingly, alert management process 10 as used in this disclosure may include any combination of alert management process 10s, alert management process 10c1, alert management process 10c2, alert management process 10c3, and alert management process 10c4.

Alert management process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a cloud-based computing network.

The instruction sets and subroutines of alert management process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of alert management processes 10c1, 10c2, 10c3, 10c4 may include but are not limited to a corporate user interface, a web browser, or a specialized application (e.g., an application running on e.g., the Android™ platform or the iOS™ platform). The instruction sets and subroutines of alert management processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to: smartphone 28; laptop computer 30; specialty device 32; personal computer 34; a notebook computer (not shown); a server computer (not shown); a dedicated network device (not shown); and a tablet computer (not shown).

Client electronic devices 28, 30, 32, 34 may each execute an operating system, examples of which may include but are not limited to Microsoft Windows™, Android™, iOS™, Linux™, or a custom operating system.

Users 36, 38, 40, 42 may access alert management process 10 directly through network 14 or through secondary network 18. Further, alert management process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, smartphone 28 and laptop computer 30 are shown wirelessly coupled to network 14 via wireless communication channels 44, 46 (respectively) established between smartphone 28, laptop computer 30 (respectively) and cellular network/bridge 48, which is shown directly coupled to network 14. Further, specialty device 32 is shown wirelessly coupled to network 14 via wireless communication channel 50 established between specialty device 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between specialty device 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth® is a telecommunications industry specification that allows e.g., mobile phones, computers, and personal digital assistants to be interconnected using a short-range wireless connection.

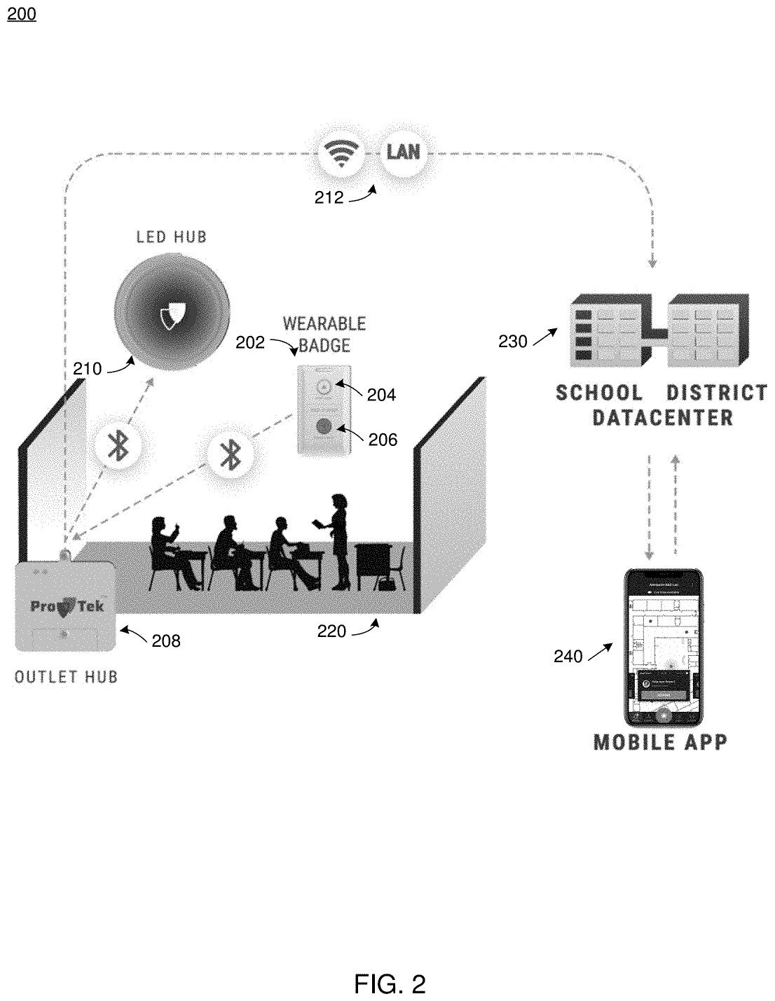

Referring to FIGS. 2-8D and as will be discussed in greater detail below, embodiments of the present disclosure may comprise a blend of hardware, software and wireless technologies to ensure fast, accurate, and reliable emergency communication when it's needed most. From alert activation to alert tracking and updating to secure two-way communication, embodiments of the present disclosure may provide a full complement of capabilities to automate and accelerate the alert and crisis management process.

As will be discussed in greater detail below, an alert can be activated instantly from multiple touchpoints, including mobile and desktop software, as well as a wearable alert activation devices that can be custom-programmed to generate various kinds of alerts (e.g., staff or building-level alerts). Whether a staff requests assistance or a higher-level alert notifying building occupants of a particular state of emergency, embodiments of the present disclosure may empower staff and administrators alike to put desired protocols in motion faster than ever.

In addition, embodiments of the present disclosure may utilize a mesh network of outlet hubs and LED hubs that provide both notifying (e.g., color-coded visual and audible alerts) and locating capability, which extends to exterior coverage, creating a robust security net that reaches places like playgrounds, athletic fields, and parking lots.

As will be discussed in greater detail below and in some implementations, outlet hubs and LED hubs may not only signal specific emergency response is needed through flashing LEDs, they may also communicate critical locating data to inform response. In some implementations, this information is instantly sent to and presented on multiple devices (desktop/laptop, mobile phone, and TV) in the form of a floor view (single location) and map view (multiple locations), and displays are updated dynamically as changes occur.

Referring also to FIG. 2, there is shown a diagrammatic view of an alert system 200 which may be configured to utilize all or parts of alert management process 10. The alert system 200 may include operations for distinct emergency alerts, for example, but not limited to, a staff alert and/or a medical alert.

As shown by the diagram of alert system 200, an alert (e.g. an emergency alert) may, first, be activated by a person, such as a staff member or a user (e.g. user 36, 38, 40, 42). Wearable badge 202 may be configured to trigger and transmit the alert. Wearable badge 202 may be configure as a specialty device (e.g. specialty device 32). Wearable badge 202 may be configured to activate an alert signal when the person presses one or more buttons, for example a first button 204 and a second button 206 on wearable badge 202.

Wearable badge 202 may be designed for instant accessibility and multi-function wireless communication capability. In some implementations, wearable badge may be an ID/access card-size (e.g., 3⅜″×2⅛″×⅛″) wearable alert device. While exemplary dimensions of an alert activation device have been discussed above, it will be appreciated that various dimensions for the alert activation device may be used within the scope of the present disclosure. In some implementations, the alert activation device may be configured to be affixed to an identification badge. For example, it can be discreetly affixed behind an identification badge and quickly engaged to initiate an alert.

One or more buttons on wearable badge 202 may be communicatively coupled to one or more transceivers. The one or more transceivers may be positioned within wearable badge 202. However, it will be appreciated that the one or more transceivers may be positioned on and/or adjacent to the exterior of wearable badge 202 and may be positioned in a variety of ways relative to the wearable badge 202 within the scope of the present disclosure. The one or more transceivers may be configured to transmit the alert signal. In some implementations, the transceiver may be configured to transmit a location of the alert activation device when transmitting the alert signal. In some implementations, the one or more transceivers may be configured to transmit and/or receive a Bluetooth signal. In other embodiments, the one or more transceivers may include a Bluetooth Low Energy® transceiver. As is known in the art, Bluetooth Low Energy® or BLE is a specification that allows radio frequency communication between various types of devices. For example, devices may provide advertising packets or signals that may be received by scanning devices. These advertising packets may be sent without a formal pairing between devices. With integrated Bluetooth Low Energy®, wearable badge 202 may allow beaconing capability for device locating. This functionality may support the capture and reporting of critical information, thus shortening response times and facilitating real-time incident updates.

In some embodiments, wearable badge 202 may be configured with second button 206. Second button 206 may be positioned below first button 204 and below an attachment point. The attachment point may be where the wearable badge 202 may be releasably attached to the person in possession of the badge. In other embodiments, more than two buttons may be utilized on wearable badge 202, and various dimensions and various configuration for wearable badge 202 may be used within the scope of the present disclosure. The alert signal may be encoded with a type of alert associated with the button. For example, in some embodiments first button 204 may be configured to activate the staff alert and second button 206 may be configured to activate a medical alert. The different type of alerts may be associated with a different group of recipients for the alert signal. For example, the medical alert may be associated with school nurses and personal with medical training. For example, the staff alert may be associated with notifying administrators if a staff member may request assistance in e.g., classroom 220. Other alerts may be associated to one or more buttons. Some embodiments may include an unlock button configured to prevent the alert signal from inadvertently activating from an accidental press of first button 204 and/or second button 206.

In some implementations, each wearable badge 202 may be associated with a user. For example, by associating each device to the wearer, the identity of the alert initiator can be communicated along with the alert signal. In some implementations, each wearable badge 202 may have a unique identifier associated with the user. In some implementations, wearable badge 202 may have a “battery weak” light. Battery strength may also be monitored within alert system 200 to ensure the system is always working. In some implementations, wearable badge 202 may have a wireless charging option that eliminates the need for replacing batteries or a battery monitoring function.

Once a button are pressed (e.g. first button 204 or second button 206), the alert system 200 activates when outlet hub 208 receives the alert signal from wearable badge 202. In some embodiments outlet hub 208 may be configured to receive the alert signal through a Bluetooth connection with wearable badge 202. Outlet hub 208 may be configured to operate as a WAP (e.g. WAP 52). One or more outlet hubs 208 may be located in each room of the building or located to ensure a signal (e.g. a Bluetooth signal) can be received from any location in the building. In embodiments configured to be used in a school, outlet hub 208 may be located in each classroom 220. In some embodiments, wearable badge 202 may be configured to communicatively couple with one or more outlet hubs 208. For example, wearable badge 202 may be configured to transmit to all outlet hubs 208 within range of a Bluetooth signal. The one or more transceivers in wearable badge 202 may communicatively couple wearable badge 202 to outlet hub 208 and/or LED hub 210.

Once outlet hub 208 receives the alert signal from wearable badge 202, outlet hub 208 is configured to transmit a signal to LED hub 210. Outlet hub 208 may be configured to communicatively couple with LED hub 210. In some embodiments, one or more transceivers positioned within outlet hub 208 may communicatively couple with one or more transceivers positioned within LED hub 210. However, it will be appreciated that the one or more transceivers positioned within outlet hub 208 and/or LED hub 210 may be positioned on and/or adjacent to the exterior surface of their respective device. The one or more transceivers may be configured to transmit and/or receive a Bluetooth signal. In other embodiments the one or more transceivers may include a Bluetooth Low Energy® transceiver.

In some implementations, the one or more transceivers positioned within outlet hub 208 and/or LED hub 210 may be configured to determine the location of wearable badge 202 relative to outlet hub 208 and/or LED hub 210. For example and in some implementations, outlet hub 208 and/or LED hub 210 may determine the location of wearable badge 202 relative to outlet hub 208 and/or LED hub 210 based upon, at least in part, the alert signal received by the one or more transceivers. In this manner, outlet hub 208 and/or LED hub 210 may determine personnel location based on the location of the alert signal generated by wearable badge 202. In some implementations, wearable badge 202 may also provide tracking capability by functioning as a locating beacon.

In some implementations, outlet hub 208 and/or LED hub 210 may be configured to receive an alert signal from the one or more wearable badge 202. In some embodiments, outlet hub 208 and/or LED hub 210 may be configured to operate as WAP 52. In some implementations, a plurality of outlet hubs 208 and a plurality of LED hubs 210 may be positioned throughout a school building.

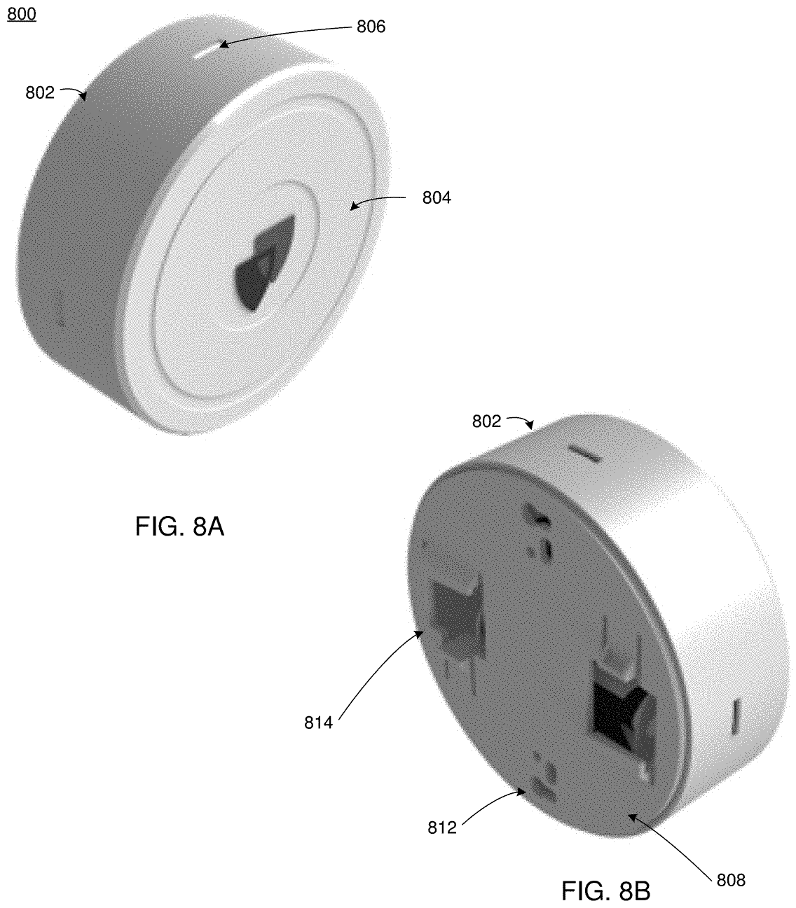

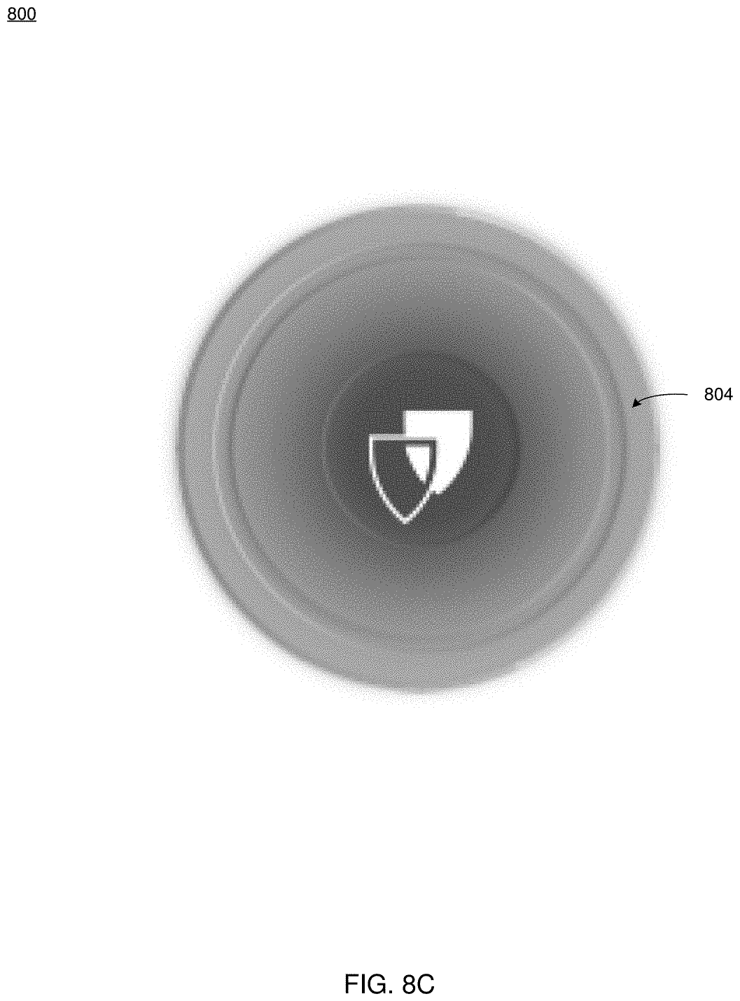

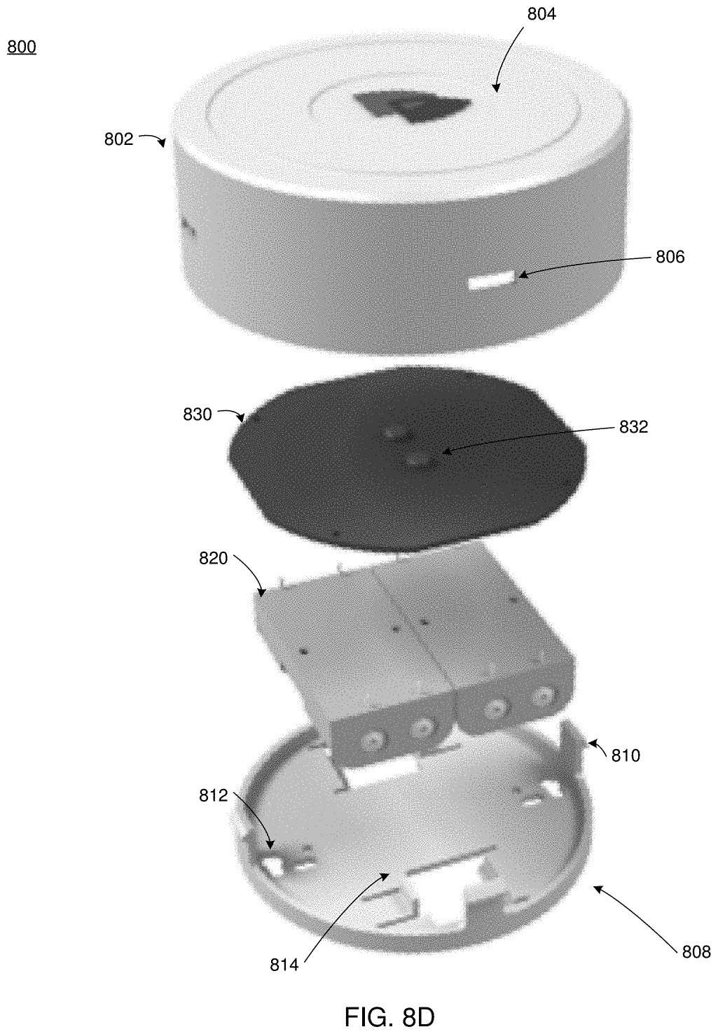

Once LED hub 210 receives the signal from outlet hub 208, LED hub 210 may begin flashing with a specific illumination color and/or illuminate with a specific color. LED hub 210 may also be configured to operate as specialty device 32. The specific illumination color may be generated by an electronically-controlled light, for example an LED (see also FIG. 8D). The specific illumination color may be associated with the type of alert generated by the button pressed on wearable badge 202. LED hub 210 may be configured to create instant awareness among building occupants by color-coded visual notification, e.g. the specific illumination color. For example, in some embodiments, when first button 204 is pressed the staff alert may be indicated by LED hub 210 illuminating and/or flashing a purple color. Additionally, in some embodiments, when second button 206 is pressed the medical alert may be indicated by LED hub 210 illuminating and/or flashing a blue color.

In some implementations other specific illumination colors may be displayed by LED hub 210 to identify the following alert events:

| | |
|---|---|
| Building Alert | (Code Red); |
| Staff Alert | (Code Blue); and |
| Medical Alert | (Code Purple). |

While the example alert events and corresponding colors have been discussed, it will be appreciated that any number of alerts and corresponding colors may be used within the scope of the present disclosure to represent any alert event(s).

Outlet hub 208 may transmit a signal 212 to a data center 230 (e.g. computing device 12) once the alert signal is received. Outlet hub 208 may be communicatively coupled to the data center 230. Communicative coupling may provide for a connection by, for example but not limited to, Wi-Fi, LAN, and/or an internet connection. In other words, outlet hub 208 and data center 208 may be configured to send and receive communication signals between one another. Outlet hub 208 may be configured to simultaneously signal LED hub 210 and data center 230 once the signal from wearable badge 202 is received. For example in some embodiments, the data center 230 may be a school district data center specifically in embodiments configured to be used in conjunction with a school.

From the data center 230, one or more client devices (e.g., smartphone 28) configured to be in communication with alert system 200 are notified if the alert applies to them. In some embodiments, alert system 200 and/or alert management process 10 may provide a user interface or application on the client device to establish a communication channel between client devices. For example, a user may select a button to establish a communication channel. In some implementations, the button may be a touchscreen button or a physical button on the client device.

Client devices may be in communication with alert system 200 via a mobile app 240. Mobile app 240 may be an application designed for smart phone or tablet operating systems such as, but not limited to, Android or Apple iOS. Mobile app 240 may be configured to receive alerts from outlet hub 208 and/or data center 230. Mobile app 240 may be configured to graphically depict, and/or textually present information such as, but not limited to, where the emergency alert was triggered, who triggered it, when the alert was triggered, what type of alert, who is responding to the alert, and other pertinent information to helping resolve the emergency alert. Alert system 200 may provide for a near-instant response, and the appropriate level of emergency response for the situation.

Client devices may include a processor and/or microprocessor configured to, e.g., process data and execute the above-noted code/instruction sets and subroutines. Microprocessor may be coupled via a storage adaptor to the above-noted storage device(s). An I/O controller may be configured to couple microprocessor with various devices, such as keyboard, pointing/selecting device, custom device, such a microphone, USB ports, and printer ports. A display adaptor may be configured to couple display with microprocessor, while network controller/adaptor may be configured to couple microprocessor to the above-noted network.

In some implementations, alert management process 10 and/or alert system 200 may be composed of applications across multiple platforms: Web (server side), Desktop and Mobile (client side). In some implementations, everything from user management to location mapping to alert and device configuration may be accessible from any Web browser. For example, desktop client applications may be installed on a computing device and may provide alert notification and activation functionality, along with full crisis management capability. In some implementations, this may include secure communication (e.g., audio/visual interaction and direct messaging) functions, plus building floor plan and multi-location map displays indicating impacted areas, with real-time information updating. It may also include quick access to emergency plans and procedures for reference.

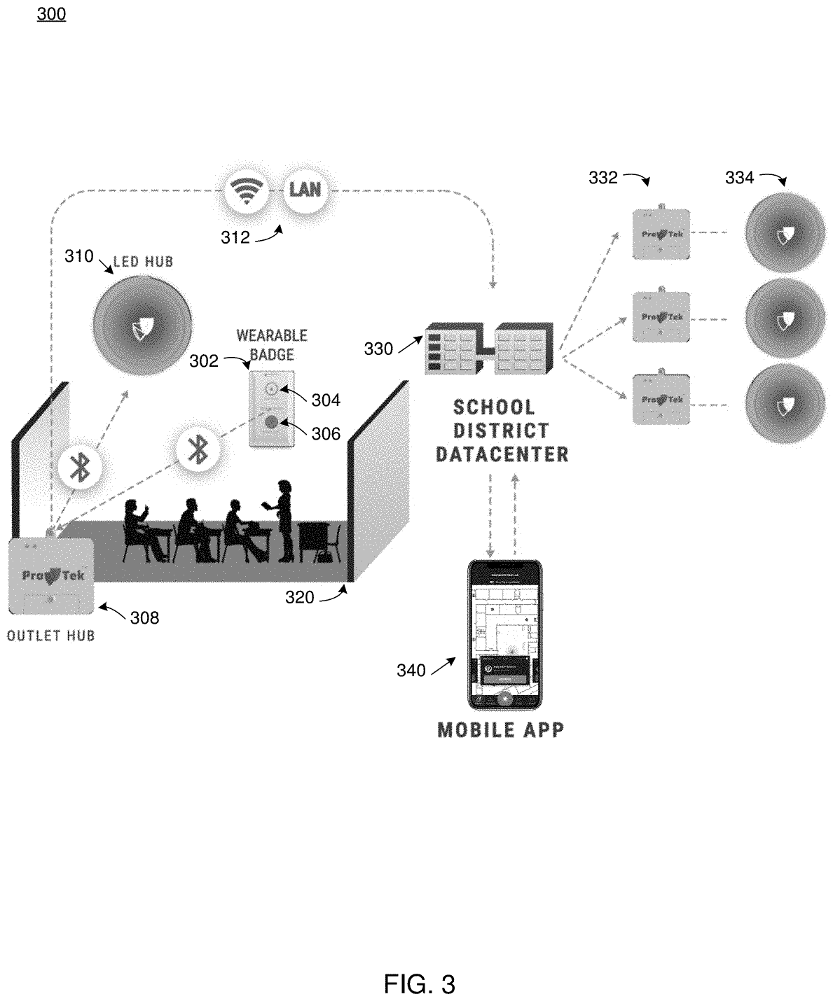

Referring also to FIG. 3, there is shown a diagrammatic view of an alert system 300 which may be configured to utilize all or parts of alert management process 10. Alert system 300, may be configured to include a building alert.

As shown by the diagram of alert system 300, an emergency alert may, first, be activated by a person, such as a staff member. Wearable badge 302 may be configured to activate an alert signal when the person presses multiple buttons on the badge at once. For example, the person may press a first button 304 and a second button 306. The multiple buttons (e.g. first button 304 and second button 306) may also be configured to individually trigger an different alert when each button is pressed individually (e.g. a staff alert and/or a medical alert as explained in reference to FIG. 2). In other embodiments, more than two buttons may be utilized to on wearable badge 302.

Once the alert system is activated, outlet hub 308 may be configured to receive the signal from wearable badge 302. In some embodiments, the outlet hub 308 may be configured to receive the signal through a Bluetooth connection with wearable badge 302. Outlet hub 308 may be located in each room of the building (e.g. classroom 320) or located to ensure a signal (e.g. a Bluetooth signal) can be received from any location in the building. In embodiments configured to be used in a school, outlet hub 308 may be located in each classroom 320.

Once outlet hub 308 receives the signal from wearable badge 302, outlet hub 308 signals LED hub 310. Outlet hub 308 may be configured to output Bluetooth signals to communicatively couple with LED hub 310. Once LED hub 310 receives the signal from outlet hub 308, LED hub 310 may begin flashing with a specific illumination color. The specific illumination color may be associated with the alert generated by the button pressed on the wearable badge 302. For example, in some embodiments, when the first button 304 and the second button 306 are pressed simultaneously, the building alert may be indicated by a red color. The building alert may, for example, be associated with notifying all staff in a specific building and/or all administrators in a school district. In this manner, inadvertently transmitting serious types of alert signals may be prevented by requiring a more involved button press configuration. While two activation buttons and two activation button press configurations have been described, it will be appreciated that any number of activation buttons and activation button press configurations may be used within the scope of the present disclosure.

In some embodiments, when a building alert or other alert is triggered, a plurality of LED hubs 334 in alert system 300 may flash with a specific illumination color or illuminate a specific illumination color once the alert is triggered.

Outlet hub 308 then may transmit a signal 312 to a data center 330. Outlet hub 308 may be communicatively coupled to the data center 330. Communicative coupling may provide for a connection with, for example but not limited to, Wi-Fi, LAN, and/or an internet connection. In other words, outlet hub 308 and data center 330 may be configured to pass communication signals between one another. Outlet hub 308 may be configured to simultaneously signal LED hub 310 and data center 330 once the signal from wearable badge 302 is received. For example in some embodiments, data center 330 may be a school district data center specifically in embodiments configured to be used in a school. In some embodiments, data center 330 may activate the plurality of LED hubs 334 by sending a signal to a plurality of outlet hubs 332 on alert system 300. The plurality of LED hubs 334 may be located in the same building as the where the alert was initially triggered. In some embodiments, each of the plurality of outlet hubs 332 may receive a signal from data center 330 and each of the plurality of LED hub 334 may begin flashing with the specified color. For example, when the building alert is triggered, every LED hub (e.g. LED hub 310 and the plurality of LED hubs 334) may begin flashing red. In some embodiments, the LED hubs may begin flashing simultaneously. In other embodiments, data center 330 may signal a plurality of outlet hubs 332 in locations where onsite help may be located, for example in a security office or an administrative office. Data center 330 may also receive multiple signals from outlet hub 332 simultaneously if multiple people trigger the same alert.

Client devices (e.g. mobile devices) configured to be in communication with alert system 300 are notified if the alert applies to them. Client devices may be notified from the data center 330 (e.g. School District Datacenter). For example in the building alert, the entire building where the building alert was triggered may be notified of the alert. Client devices may be in communication with alert system 300 via mobile app 340. Mobile app 340 may be an application designed for smart phone or tablet operating systems such as, but not limited to, Android or Apple iOS. Mobile app 340 may be configured to receive alerts from outlet hub 308 and/or data center 330 (e.g. school district data center). Mobile app 340 may be configured to graphically depict, and/or textually present information such as, but not limited to, where the emergency alert was triggered, who triggered it, when the alert was triggered, what type of alert, who is responding to the alert, and other pertinent information to helping resolve the emergency alert. Alert system 300 may provide for a near-instant response, and the appropriate level of emergency response for the situation.

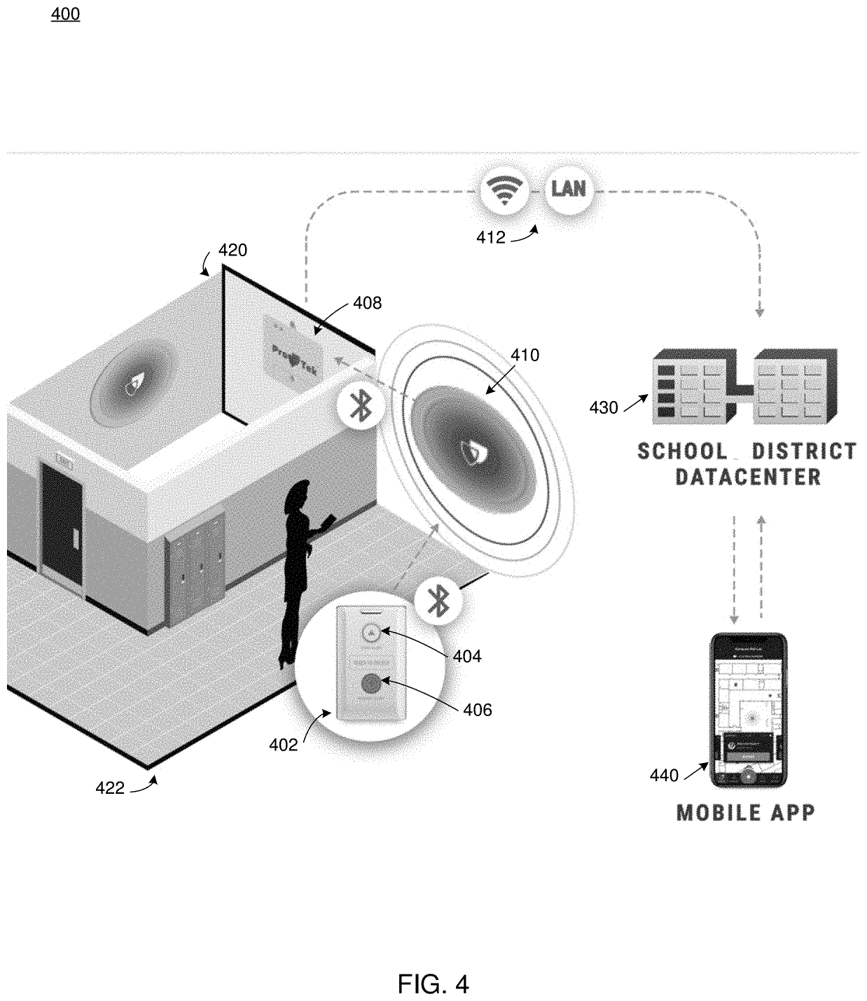

Referring also to FIG. 4, there is show a diagrammatic view of alert system 400 depicting an example of an emergency alert triggered in a hallway 422, or other location without an outlet hub 408 directly nearby. Emergency alerts may include a staff alert and/or a medical alert. A staff alert may be activated by a person pressing a first button 404 on a wearable badge 402. Similarly, a medical alert may be activated by a person pressing a second button 406 on wearable badge 402.

Once first button 404 or second button 406 is pressed, alert system 400 may be configured to activate when the nearest LED hub 410 receives the signal from wearable badge 402. In embodiments configured for a school, LED hub 410 may be located in a nearby classroom 420. LED hub 410 may be communicatively coupled with the wearable badge 402 by for example, but not limited to a Bluetooth connection. Once LED hub 410 receives the signal from wearable badge 402, LED hub 410 may begin flashing with a specific illumination color. The specific illumination color may be associated with the alert generated by wearable badge 402. For example, when first button 404 is pressed the staff alert may be indicated by a purple color. Additionally, for example in some embodiments, when second button 406 is pressed the medical alert may be indicated by a blue color.

LED hub 410 may be configured to alert data center 430 (e.g. a school district data center) by relaying the alert through outlet hub 408. LED hub 410 may send the alert to the outlet hub 408 by a Bluetooth connection. Outlet hub 408 is configured to have a Wi-Fi, LAN, and/or internet connection 412 with data center 430. LED hub 410 may be configured to simultaneously flash with a specific illumination color and signal data center 430 through the connectivity of outlet hub 408 with data center 430 once the person activates an alert through wearable badge 404. In some embodiments, LED hub 410 and outlet hub 408 may operate as two hubs configured to provide the alert to data center 430. LED hub 430 may also be configured to have a Wi-Fi, LAN, and/or internet connection with data center 430 through outlet hub 408.

Client devices (e.g. smartphone 28) configured to be in communication with alert system 400 are notified if the alert applies to them. Client devices may be notified from the data center 430 (e.g. school district data center). Similarly to FIGS. 2 and 3, client devices (e.g. mobile devices) may be in communication with alert system 400 via mobile app 440. Mobile app 440 may provide notifications to create a near-instant response, and the appropriate level of emergency response for the situation.

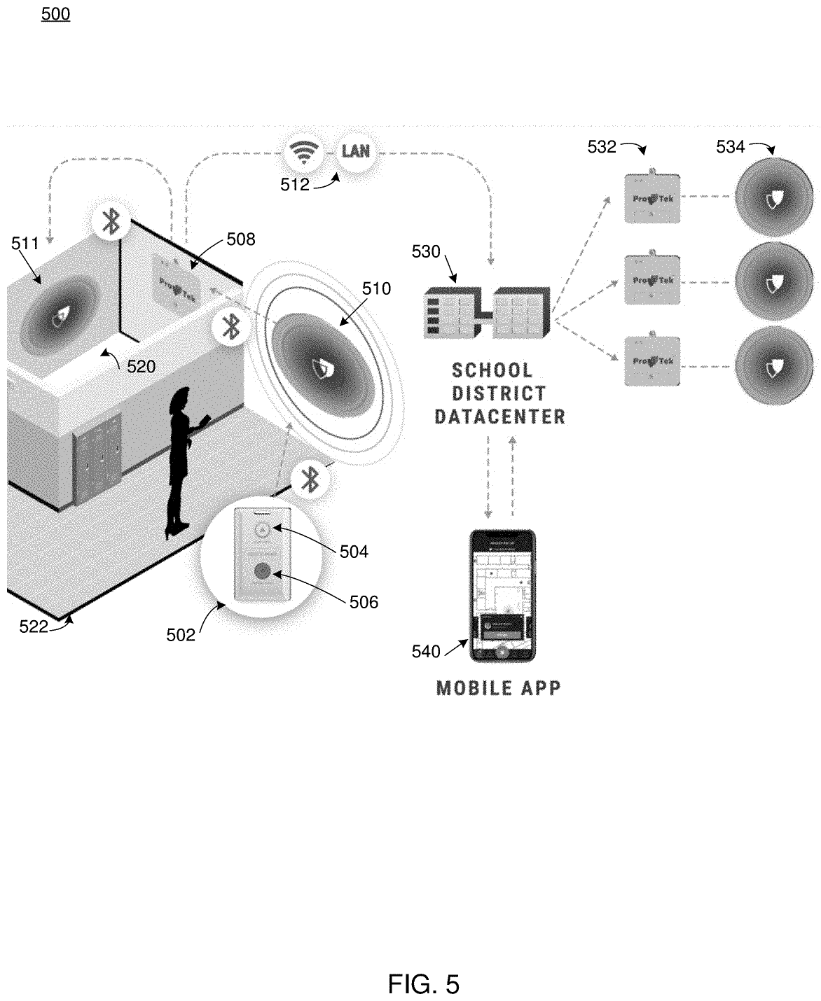

Now referring to FIG. 5, there is shown a diagrammatic view of alert system 500 depicting an example of an emergency alert triggered in a hallway 522 or other location without an outlet hub 508 directly nearby. Emergency alerts may include a building alert. In addition to the details provided in reference to FIG. 4, the building alert may be activated by a person pressing a first button 504 and a second button 506 on a wearable badge 502 at the same time.

Once first button 504 and second button 506 is pressed, the building alert may be configured to activate when the nearest LED hub 510 receives the signal from wearable badge 502. The wearable badge 502 is communicatively coupled with outlet hub 508 and LED hub 510. Outlet hub 508 may be positioned in a different room, e.g. classroom 520, than LED hub 510. Once the building alert is activated, LED hub 510 may begin flashing a specific illumination color, such as red. LED hub 510 may be configured to alert a data center 530 (e.g. a school district data center) by a Bluetooth connection with outlet hub 508 and using the connectivity of outlet hub 508 with data center 530. Outlet hub 508 is configured to have a Wi-Fi, LAN, and/or internet connection 512 with data center 530. Outlet hub 508 may be configured to activate other LED hubs that it is wirelessly connected, such as LED hub 511, to once a building alert is activated by wearable badge 502. Data center 530 may activate a plurality of LED hubs 534 connected with alert system 500 to start flashing the specified color. The plurality of LED hubs 534 may be connected to alert system 500 through a plurality of outlet hub 532. Activation of other LED hubs 534 may occur automatically. In some embodiments, the plurality of LED hubs 534 may be located in the same building where the building alert was initially triggered. In other embodiments, the plurality of LED hubs 534 may be all the LED hubs (e.g. LED hub 510, LED hub 511, and the plurality of LED hubs 534) connected to alert system 500. Datacenter 530 may also notify users of the alert via mobile app 540.

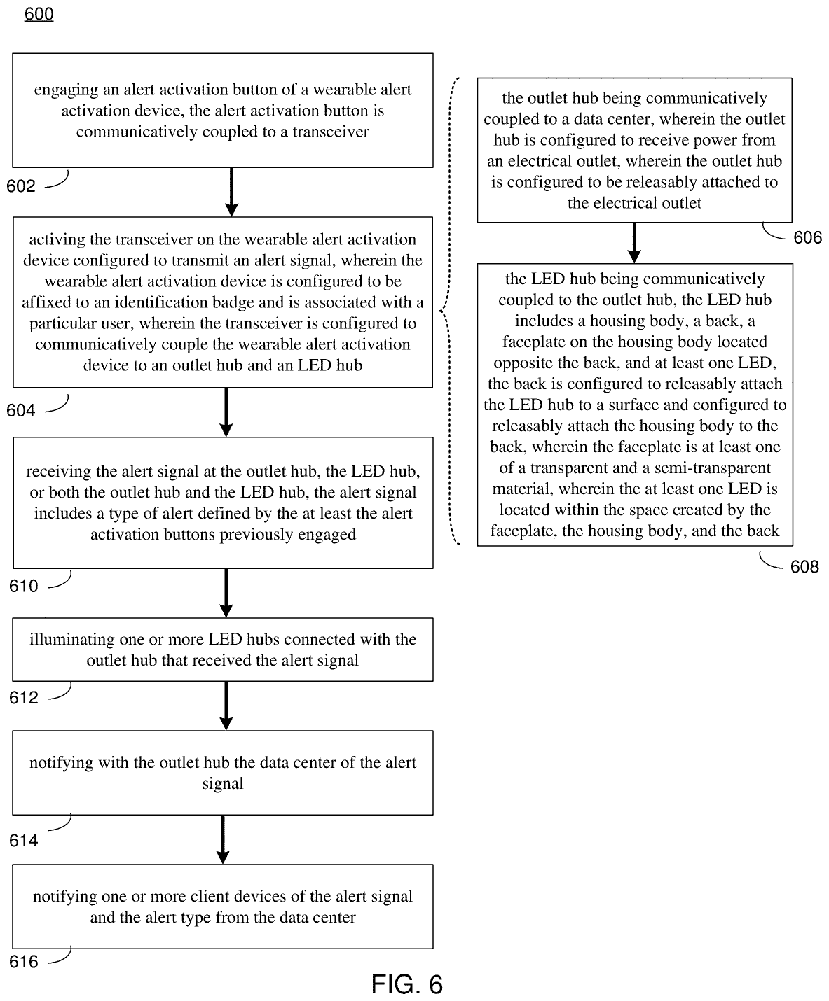

Referring also to FIG. 6, an exemplary flow chart of alert management process 600 is depicted. The method may include engaging (602) an alert activation button of a wearable alert activation device, the alert activation button is communicatively coupled to a transceiver. The method may include activing (604) the transceiver on the wearable alert activation device configured to transmit an alert signal, wherein the wearable alert activation device is configured to be affixed to an identification badge and is associated with a particular user, wherein the transceiver is configured to communicatively couple the wearable alert activation device to an outlet hub (606) and an LED hub (608). The outlet hub (606) may be communicatively coupled to a data center, wherein the outlet hub is configured to receive power from an electrical outlet, wherein the outlet hub is configured to be releasably attached to the electrical outlet. The LED hub (608) may be communicatively coupled to the outlet hub, the LED hub includes a housing body, a back, a faceplate on the housing body located opposite the back, and at least one LED, the back is configured to releasably attach the LED hub to a surface and configured to releasably attach the housing body to the back, wherein the faceplate is at least one of a transparent and a semi-transparent material, wherein the at least one LED is located within the space created by the faceplate, the housing body, and the back. The method may further include receiving (610) the alert signal at the outlet hub, the LED hub, or both the outlet hub and the LED hub, the alert signal includes a type of alert defined by the at least the alert activation buttons previously engaged. The method may include illuminating (612) one or more LED hubs connected with the outlet hub that received the alert signal and notifying (614) with the outlet hub the data center of the alert signal. The method may further include notifying (616) one or more client devices of the alert signal and the alert type from the data center.

One or more of the following features may be included in alert management process 600. The method may further include illuminating one or more LED hubs positioned in a school district with a specific illumination color from the data center based on at least the alert type and the data center may be positioned in the school district. Simultaneously engaging two alert activation buttons may transmit a different type of alert then the type of alert transmitted from engaging either of the two alert activation buttons individually. The illuminating one or more LED hubs connected with the outlet hub that received the alert signal and the notifying the data center of the alert signal with the outlet hub, may occur simultaneously. The outlet hub may be communicatively coupled to at least one LED hub by a Bluetooth® signal and the outlet hub may be communicatively coupled to the data center by at least one of an Ethernet and a Wi-Fi connection. The method may also include providing to the one or more client devices the type of alert signal that was transmitted, a location of the alert signal, and an identity of the user.

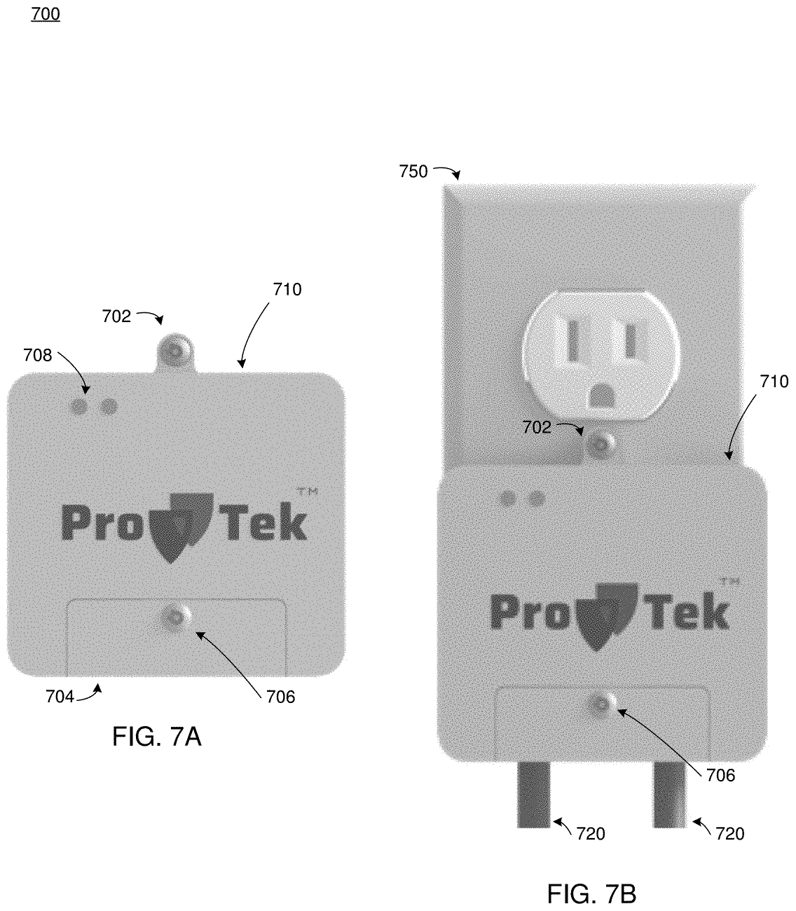

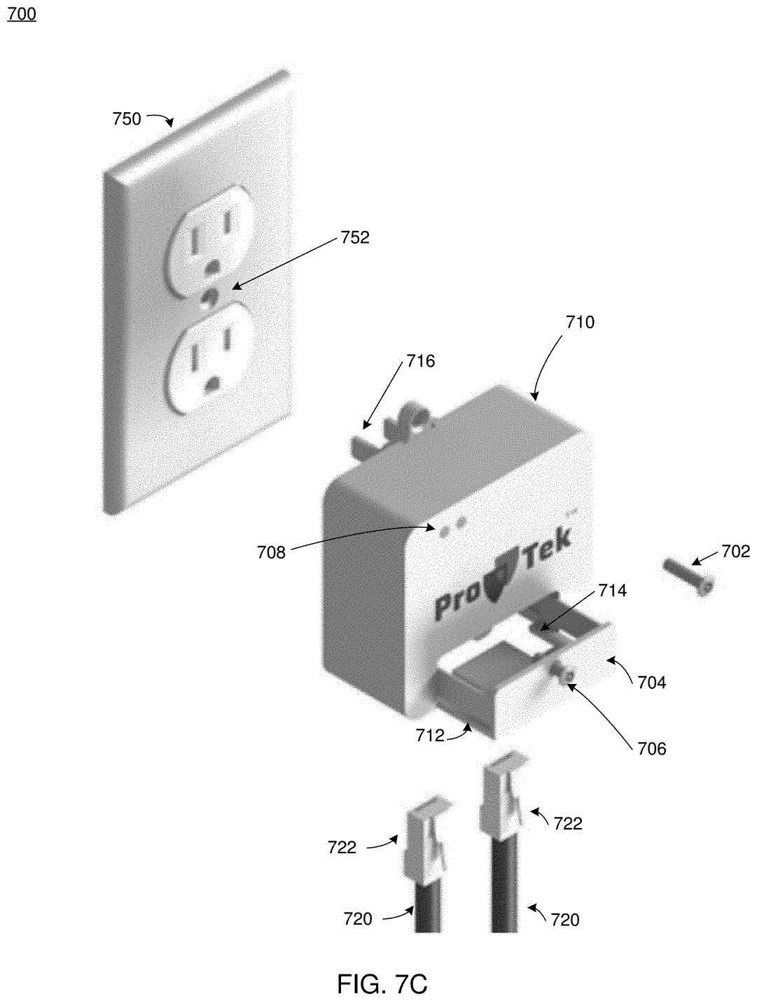

Referring also to FIG. 7A, FIG. 7B, and FIG. 7C, different views of an embodiment of an outlet hub 700 are provided.

FIG. 7A depicts a front view of outlet hub 700. Outlet hub 700 may include an outlet screw 702, a cable cover 704, a cable cover screw 706, an indicator light 708, and an outlet hub body 710. Cable cover 704 may be releasably attachable to outlet hub body 710. Cable cover screw 706 may releasably attach cable cover 704 to outlet hub body 710. Cable cover screw 706 may be a security screw or other mechanism configured to prevent unauthorized access to outlet hub body 710.

Outlet hub 700 may include a plurality of indicator lights 708. Indictor light 708 may be configured to visually notify a person the status of the device. For example indicator light 708 may visually depict connectivity with LED hub, and/or data centers (e.g. school district data center), and indicator light may indicate whether the outlet hub 700 has power.

FIG. 7B depicts the front view of outlet hub 700 installed in outlet 750. Outlet screw 702 may be configured to screw directly into outlet 750. Outlet 750 may be a conventional household electrical outlet capable of providing AC power from a municipal electrical grid. Outlet screw 702 may be a security screw or other mechanism configured to prevent unauthorized tampering or removal. Outlet hub 700 may acquire all the required power to operation from electrical prongs configured to be inserted into (i.e. electrical prongs 716 shown in FIG. 7C). Outlet hub 700 may include a backup generator and/or a backup power supply configured to keep outlet hub 700 communicably coupled with the data center and/or one or more LED hubs.

Cable 720 may be inserted into the female connector within outlet body 710 and then secured into outlet hub 700 by cable cover 704 and cable cover screw 706. In some embodiments, cable 720 may be one or more Ethernet cables.

FIG. 7C depicts an exploded view of outlet hub 700. As can be seen better in FIG. 7C, cable cover 704 may include an extending mechanism 712 that can securely wrap around the cable plug 722 and cable 720 when the extending mechanism 712 is retracted into outlet hub body 710 and secured by cable cover screw 706. Extending mechanism 712 may extend far enough from outlet hub body 710 to allow cable plug 722 to connect with the female connector within outlet body 710. The female connector within outlet body 710 and cable 720 are configured to communicatively couple outlet hub 700 to a data center (e.g. data center 230, 330, 430, 530). In other embodiments, outlet hub 700 may include wireless hardware configured to communicatively coupled outlet hub 700 to the data center without cable 720. In some embodiments, cable cover 704 may include a cutout 714 configured to surround cable 720 once cable plug 722 has been attached to outlet hub 700.

Outlet hub 700 may be releasably attached to outlet 750. Specifically outlet screw 702 may pass through outlet body 710 into threaded hole 752. Outlet hub body 710 may be configured to allow electrical prongs 716 to be plugged into outlet 750 when outlet screw 702 has releasably attached outlet body 710, specifically releasably attached to threaded hole 752.

Now referring to FIG. 8A, FIG. 8B, FIG. 8C, and FIG. 8D, different views of LED hub 800 are provided. LED hub 800 may include an LED 832, a housing body 802, a faceplate 804, a female mounting point 806, a back 808, a male mounting point 810, a hub mounting point 812, hub access 814, electronics 820, a board 830, and LED 832.

FIG. 8A depicts a front view of LED hub 800. Housing body 802 may include a faceplate 804 and female mounting point 806. Faceplate 804 may be a transparent or semi-transparent material configured to allow light to pass from inside the housing body 802 through the faceplate 804.

FIG. 8B depicts a back view of LED hub 800. Back 808 includes hub mounting point 812 and hub access 814. Hub mounting point 812 is configured to secure back 808 of LED hub 800 to another surface such as, but not limited to, a wall or a ceiling. Hub access 814 surrounds a space cut out from back 808. Hub access 814 is configured to allow cables, such as a power cable, to connect to electronics 820 (shown in FIG. 8D).

FIG. 8C depicts a view of LED hub 800 looking directly at faceplate 804 with LED 832 illuminated. As can be seen in this figure LED 832 may illuminate faceplate 804 with a specific illumination color. As mentioned in reference to FIGS. 2-5, LED 832 may be configured to generate specific illumination colors as a result of the specific alert triggered by a person with a device, such as a wearable badge. LED 832 may illuminate a portion of faceplate 804 or all of faceplate 804.

FIG. 8D depicts an exploded view of LED hub 800. LED hub 800 may include male mounting point 810 connected to back 808. Housing body 802 may be configured to enclose LED 832, electronics 820, and male mounting point 810 when housing body 802 is releasably attached to back 808. Male mounting point 810 may be configured to mate to female mounting point 806 thereby releasably attaching housing body 802 to back 808. In other embodiments, male mounting point 810 may be attached to housing body 802 and female mounting point 806 may be attached to back 808. In some embodiments male mounting point may include a protrusion configured to be inserted into female mounting point 806.

Electronics 820 may be attached to back 808. Electronics 820 may be configured to receive a signal from an outlet hub (e.g. outlet hub 700). Specifically in some embodiments, electronics 820 may be configured to receive a Bluetooth signal. Electronics 820 may be electrically in communication with board 830 to power LED 832. In some embodiments, board 830 may include a plurality of LED 832. LED 832 may be a single color LED or a multicolor LED. LED 832 may be configured to emit a specific light depending on the signal from outlet hubs and/or wearable badges. Electronics 820 may also include a power supply, a backup generator and/or a backup power supply. The backup generator and/or the backup power supply may be configured to keep LED hub 800 communicably coupled with the data center and/or one or more outlet hubs. The power supply may include for example but not limited to a battery. In some embodiments of LED hub 800 there may be no power supply and LED hub 800 may include a power input connection configured to receive power from a municipal electrical grid (e.g. electrical prongs 716).

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

1. An alert management system comprising:
an outlet hub, the outlet hub being communicatively coupled to a data center, wherein the outlet hub is configured to receive power from an electrical outlet, the outlet hub includes an outlet hub body, and an indicator light positioned on the outlet hub body, wherein the outlet hub is configured to be releasably attached to the electrical outlet;
an LED hub communicatively coupled to the outlet hub, the LED hub includes a housing body, a back, a faceplate on the housing body located opposite the back, and at least one LED, the back is configured to releasably attach the LED hub to a surface and configured to releasably attach the housing body to the back, wherein the faceplate is at least one of a transparent and a semi-transparent material, wherein the at least one LED is located within the space created by the faceplate, the housing body, and the back; and
one or more wearable alert activation devices communicatively coupled to at least one outlet hub, wherein the one or more wearable alert activation devices include:
a transceiver configured to communicatively couple the wearable alert activation device to the outlet hub and to the LED hub, wherein the wearable alert activation device is configured to be affixed to an identification badge and is associated with a particular user; and
an activation button communicatively coupled to the transceiver;
wherein the wearable alert activation device is configured to transmit an alert signal that identifies the user and is transmitted at least partially within a building via the transceiver in response to a user engaging the alert activation button, wherein the alert activation button defines a type of alert, wherein the wearable alert activation device includes two or more activation buttons, wherein each alert activation button defines a different type of alert and wherein the type of alert defines a number of LED hubs that illuminate a specific illumination color and wherein the type of alert defines a location of the LED hubs that illuminate the specific illumination color.

2. (canceled)

3. The alert management system of claim 1, wherein simultaneously engaging two alert activation buttons transmits a different type of alert then the type of alert transmitted from engaging either of the two alert activation buttons individually.

4. The alert management system of claim 3, wherein the type of alert defines a different group of recipients for the alert signal and defines a specific illumination color of the LED hub, wherein the LED hub is configured to illuminate the specific illumination color.

5. (canceled)

6. The alert management system of claim 1, wherein the type of alert includes a building alert, the building alert includes illuminating all LED hubs communicably coupled to the data center.

7. The alert management system of claim 1, wherein one or more outlet hubs and one or more LED hubs are positioned throughout a school district, wherein the building is a school building, wherein the data center is positioned in the school district.

8. The alert management system of claim 1, wherein the LED hub is configured to receive the alert signal and communicate the alert signal to the data center, wherein the outlet hub is configured to receive the alert signal and communicate the alert signal to the data center.

9. The alert management system of claim 1, wherein at least one of the outlet hub and the LED hub includes a backup power supply.

10. The alert management system of claim 1, wherein the outlet hub is communicatively coupled to at least one LED hub by a Bluetooth® signal, wherein the outlet hub is communicatively coupled to the data center by at least one of an Ethernet and a Wi-Fi connection.

11. The alert management system of claim 1, wherein the outlet hub is configured to simultaneously communicate the alert signal from the wearable alert activation device to the LED hub and to the data center.

12. The alert management system of claim 1, wherein the data center is configured to transmit the alert signal from the wearable alert activation device to one or more client devices, wherein each client device is configured to receive from the data center a notification of the alert signal, the notification of the alert signal includes the type of alert signal that was transmitted, a location of the alert signal, and an identity of the user.

13. The alert management system of claim 12, wherein the data center is configured to notify through the outlet hub one or more LED hubs in a school district to illuminate a specific illumination color based on at least the type of alert and the location of each LED hub.

14. The alert management system of claim 1, wherein the LED hub is configured to receive the alert signal from the wearable alert activation device and send the alert signal to the outlet hub.

15. The alert management system of claim 14, wherein if the outlet hub receives the alert signal from the LED hub and the LED hub received the alert signal from the wearable alert activation device then the outlet hub simultaneously transmits the alert signal to the data center and transmits the alert signal to other LED hubs in range.

16. The alert management system of claim 1, wherein the outlet hub includes a cable cover configured to allow a cable to be mated with a cable connector positioned on the outlet hub body, the cable cover configured to surround a portion of the cable with the outlet hub body when the cable cover is releasably attached to the outlet body.

17. A method of alert management, the method comprising:
engaging an alert activation button of a wearable alert activation device, the alert activation button is communicatively coupled to a transceiver;
activing the transceiver on the wearable alert activation device configured to transmit an alert signal, wherein the wearable alert activation device is configured to be affixed to an identification badge and is associated with a particular user, wherein the transceiver is configured to communicatively couple the wearable alert activation device to:
an outlet hub, the outlet hub being communicatively coupled to a data center, wherein the outlet hub is configured to receive power from an electrical outlet, wherein the outlet hub is configured to be releasably attached to the electrical outlet; and
an LED hub, the LED hub being communicatively coupled to the outlet hub, the LED hub includes a housing body, a back, a faceplate on the housing body located opposite the back, and at least one LED, the back is configured to releasably attach the LED hub to a surface and configured to releasably attach the housing body to the back, wherein the faceplate is at least one of a transparent and a semi-transparent material, wherein the at least one LED is located within the space created by the faceplate, the housing body, and the back;
receiving the alert signal at the outlet hub, the LED hub, or both the outlet hub and the LED hub, the alert signal includes a type of alert defined by the at least the alert activation buttons previously engaged;
illuminating one or more LED hubs connected with the outlet hub that received the alert signal, wherein the type of alert defines a plurality of LED hubs that illuminate a specific illumination color and wherein the type of alert defines a location of the LED hubs that illuminate the specific illumination color;
notifying with the outlet hub the data center of the alert signal; and
notifying one or more client devices of the alert signal and the alert type from the data center.

18. The method of alert management of claim 17, wherein simultaneously engaging two alert activation buttons transmits a different type of alert then the type of alert transmitted from engaging either of the two alert activation buttons individually.

19. The method of alert management of claim 17, wherein the illuminating one or more LED hubs connected with the outlet hub that received the alert signal and the notifying the data center of the alert signal with the outlet hub, occur simultaneously.

20. The method of alert management of claim 17, further comprising:
providing to the one or more client devices the type of alert signal that was transmitted, a location of the alert signal, and an identity of the user.
